(19) United States
(12) Patent Application Publication
(10) Pub. No.: US 2022/0079112 A1
(43) Pub. Date: Mar. 17, 2022

(54) PET BED

(71) Applicants: SEAN OATEN, SYDNEY (AU); Caitlin Kemp, Sanctuary Point (AU)

(72) Inventors: SEAN OATEN, SYDNEY (AU); Caitlin Kemp, Sanctuary Point (AU)

(21) Appl. No.: 17/531,712

(22) Filed: Nov. 20, 2021

(51) Int. Cl. A01K 1/035; A01K 1/015

(52) U.S. Cl. CPC A01K 1/0353; A01K 1/015

(57) ABSTRACT

Presented is a pet bed and method for assembly and disassembly of the pet bed. The pet bed comprises a top cover, a bottom cover and a plurality of sidewalls. The top cover as well as the bottom cover comprises two extension portions positioned on either sides of the top cover and the bottom cover. In an embodiment of the present invention, the pet bed comprises atleast a scratcher to allow pet to express their urge of scratching on the scratcher. The pet bed provides the advantages that it is transportable, can be easily assembled and disassembled with ease and the same time; provide comfort to the pet during use.

### TECHNICAL FIELD OF INVENTION

The present invention generally relates to pet beds and more particularly, it pertains to a pet bed that can be easily assembled and disassembled for later use.

### BACKGROUND

Pets are an integral part of many households across the world. Many people adopt or buy various kinds of pet animals such as but not limited to dogs, cats, rabbits, guinea pigs and so on. Pets offer companionship, pleasure and joy to many people specially children. For pet comfort during sleep, people either manually make beds themselves from materials such as wood, plastic, cardboard, leather and so on which takes a considerable amount of time and effort of the person building the pet bed. Further, these pet beds are not always properly designed/constructed due to lack of craftsmanship of the person building the pet bed.

Further, many people purchase pet beds from various sellers in the market. These pet beds are available in different shapes, sizes and colors and provide customary solutions to meet needs of various pets. These pet beds are transportable for ease of carrying the pet by the pet owner. Further, these pet beds are cushioned (soft padded) for comfort of the animal.

Existing pet beds requires tools such as but not limited to screw drivers, one time use tools and so on for carrying out assembly and disassembly of pet bed. These tools are not always readily available such as during travel and loss/non-availability of the tool limits the ability to assemble and disassemble the pet bed. Further, one time use tools are usually thrown in the environment after use, thus adding to the overall burden on eco-system.

Further, many pets such as cats and dogs like to scratch a surface from their paws or jaws for various reasons such as but not limited to: entertainment, comfort, marking territory, paw nail discomfort, express emotions/stress and so on. Typically, they express their urge of scratching on furniture or other valuable household items, thus damaging the appearance of the household items. Many products such as scratching posts provide a solution to scratching needs of pet. These scratching posts provide an alternative place for scratching such that pet does not express their urge of scratching on furniture and other valuable household items.

Various pet beds are known in the prior art attempting to meet various needs of pets. For example, U.S. Pat. No. 8,347,815B2 discloses a mobile pet bed wherein the top and bottom units of the mobile pet bed are reversibly attached to each other. When the top unit is removed from the bottom unit the mobile pet bed functions similarly to a traditional pet bed. When the top unit is attached to the bottom unit the mobile pet bed functions as a pet carrier. Additionally, the top unit of the mobile pet bed has a door portion that can be opened and closed to permit pet ingress and egress as well as permitting easy loading of the mobile pet bed with the animal without necessitating the removal of the top unit from the bottom unit.

The existing pet beds do not provide an effective solution due to its cumbersome design, manufacturing costs and difficulty in transporting pet bed across various places. The existing pet beds do not provide a solution to the pet needs of scratching while using the pet bed and thus, it does increases the discomfort of the pet. Thus, there is a need for a pet bed that is transportable, can be easily assembled and disassembled with ease and the same time, provide comfort to the pet.

### BRIEF SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

It is an object of the present invention to provide a pet bed for comfort of the pet.

It is an object of the present invention to provide a pet bed that can be easily assembled and disassembled for later use.

It is an object of the present invention to provide a pet bed comprising atleast a scratcher to allow pet to express their urge of scratching on the scratcher.

Embodiments of the present invention disclose a pet bed that can be easily brought from an assembled position to a disassembled position and vice versa; the pet bed comprises:—A top cover comprising two extension portions positioned on either sides of the top cover wherein each extension portion comprises a plurality of holes; A bottom cover comprising two extension portions positioned on either sides of the bottom cover wherein each extension portion comprises a plurality of holes; A Plurality of sidewalls wherein each sidewall is formed from a plurality of tubes; each tube comprising a first end and an opposite second end; wherein in the assembled position, the first end of the plurality of tubes is removably received in the plurality of holes of the extension portion; and the second end of the plurality of tubes is removably received in the plurality of holes of the extension portion such that the top cover, the bottom cover and the plurality of sidewalls are connected to define an enclosure for receiving atleast one pet animal; Wherein in the disassembled position, the first end of the plurality of tubes is detached from the plurality of holes of the extension portion; and the second end of the plurality of tubes is detached from the plurality of holes of the extension portion.

In an embodiment, the pet bed comprises a cushion element removably positioned on the bottom cover to provide a cushioning effect to the pet animal.

In an embodiment, the pet bed comprises two door portions for entry and/or exit of the pet animal from the pet bed.

In an embodiment, the plurality of tubes plurality of holes and/or plurality of holes includes a friction lining material to facilitate a stronger connection between the plurality of tubes and the plurality of holes and/or plurality of holes.

Embodiments of the present invention further disclose a pet bed that can be easily brought from an assembled position to a disassembled position and vice versa; the pet bed comprising:—A top cover comprising two extension portions positioned on either sides of the top cover; wherein each extension portion comprises a plurality of holes and an elongate slot; A bottom cover comprising two extension portions positioned on either sides of the bottom cover; wherein each extension portion comprises a plurality of holes and an elongate slot; Atleast one first sidewall and atleast one second sidewall; Wherein atleast one First sidewall is formed from a plurality of tubes and atleast one scratcher; wherein each tube comprising a first end and an opposite second end; wherein each scratcher comprises a first elongate protrusion and an opposite second elongate protrusion; wherein in the assembled position, the first end of the plurality of tubes is removably received in the plurality of holes of the extension portion; the second end of the plurality of tubes is removably received in the plurality of holes of the extension portion; the first elongate protrusion of the scratcher is removably received in the elongate slot of the top cover and the second elongate protrusion of the scratcher is removably received in the elongate slot of the bottom cover such that the top cover, the bottom cover, the first sidewall and the second sidewall are connected to define an enclosure for receiving atleast one pet animal; wherein in the disassembled position, the first end of the plurality of tubes is detached from the plurality of holes of the extension portion; the second end of the plurality of tubes is detached from the plurality of holes of the extension portion; the first elongate protrusion of the scratcher is detached from the elongate slot of the top cover and the second elongate protrusion of the scratcher is detached from the elongate slot of the bottom cover.

In an embodiment, the pet bed comprises a cushion element removably positioned on the bottom cover to provide a cushioning effect to the pet animal.

In an embodiment, the pet bed comprises two door portions for entry and/or exit of the pet animal from the pet bed.

In an embodiment, the plurality of tubes, plurality of holes and/or plurality of holes includes a friction lining material to facilitate a stronger connection between the plurality of tubes and the plurality of holes and/or plurality of holes.

In an embodiment, the second sidewall is formed from atleast one scratcher and a plurality of tubes.

In an embodiment, the second sidewall is formed from a plurality of tubes.

In an embodiment, the scratcher comprises a replaceable covering that can be secured on the outer surface of the scratcher.

In an embodiment, the scratcher forms up a percentage ranging from 5 percent to 95 percent of overall dimensions of the first sidewall.

Various objects, features, aspects and advantages of the present invention will become more apparent from the following detailed description of the embodiments of the invention, along with the accompanying drawings in which like numerals represent like components.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 illustrates a perspective view of a pet bed in an assembled position, according to an embodiment of the present invention;

FIG. 2 illustrates an exploded view of the pet bed of FIG. 1;

FIG. 3 illustrates a front view of the pet bed of FIG. 1;

FIG. 4 illustrates a side view of the pet bed of FIG. 1;

FIG. 5 illustrates a top view of the pet bed of FIG. 1;

FIG. 6 illustrates a perspective view of a pet bed, according to another embodiment of the present invention;

FIG. 7 illustrates an exploded view of the pet bed of FIG. 6;

FIG. 8 illustrates a front view of the pet bed of FIG. 6;

FIG. 9 illustrates a side view of the pet bed of FIG. 6;

FIG. 10 illustrates a top view of the pet bed of FIG. 6;

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

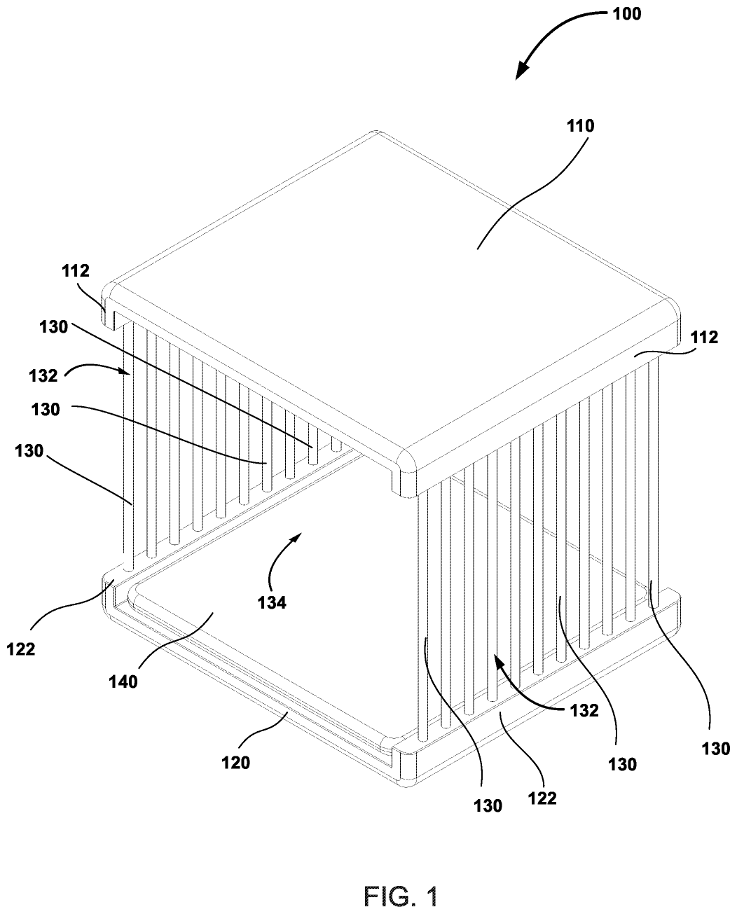

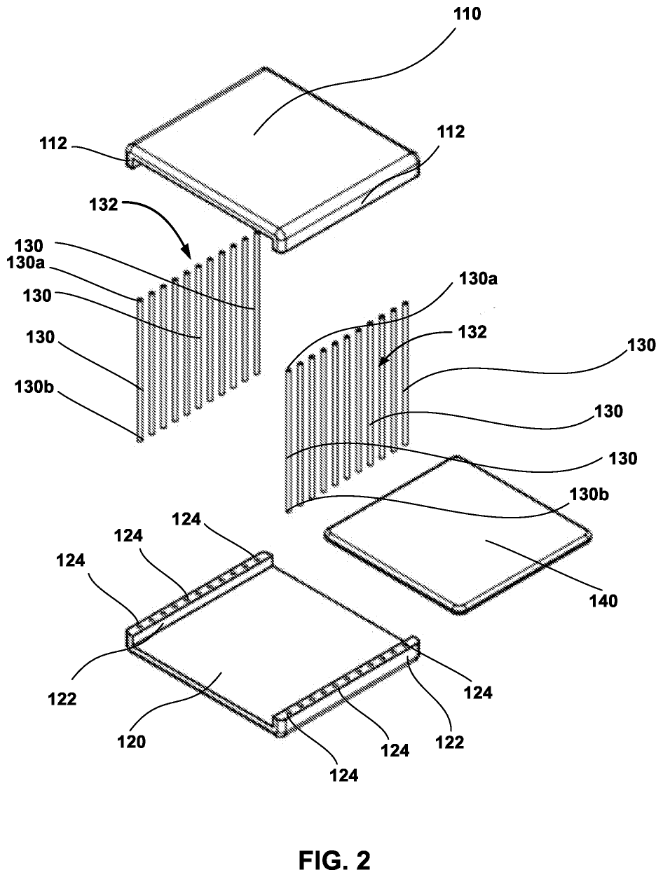

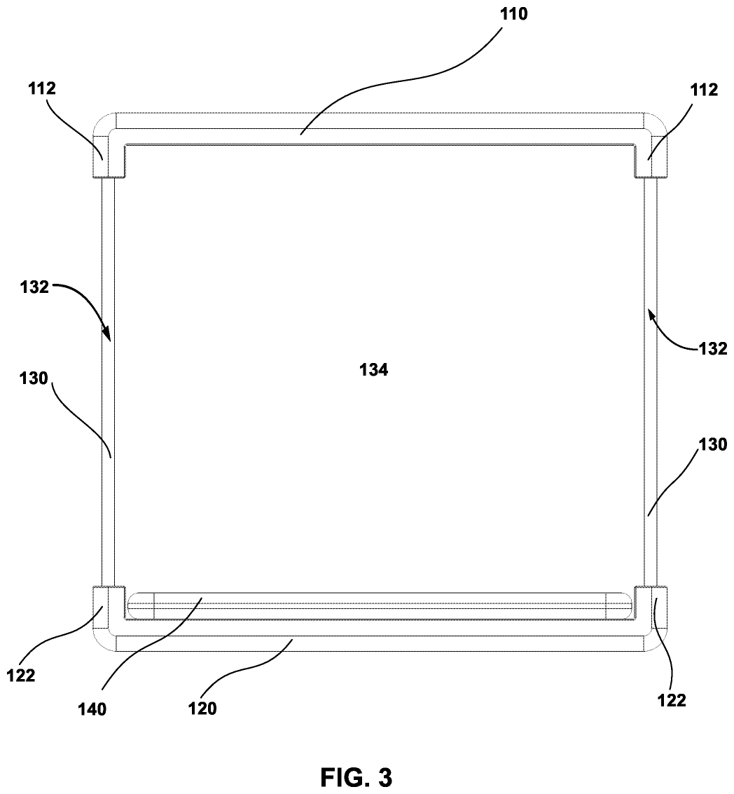

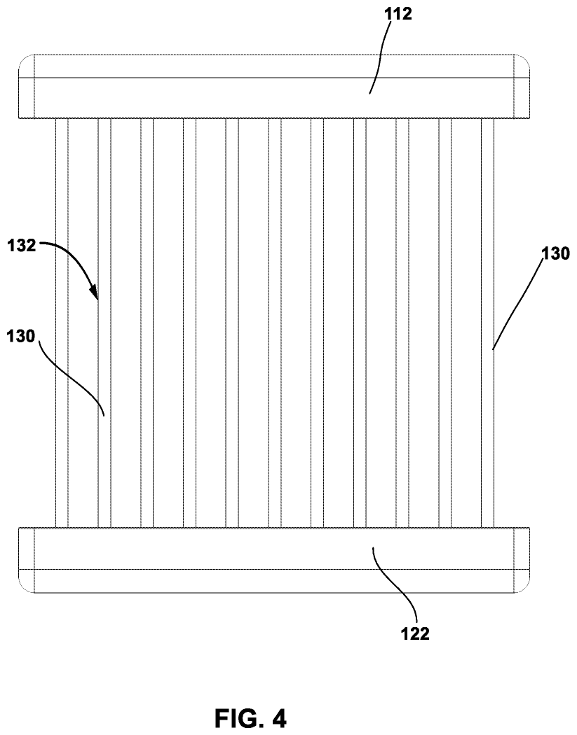

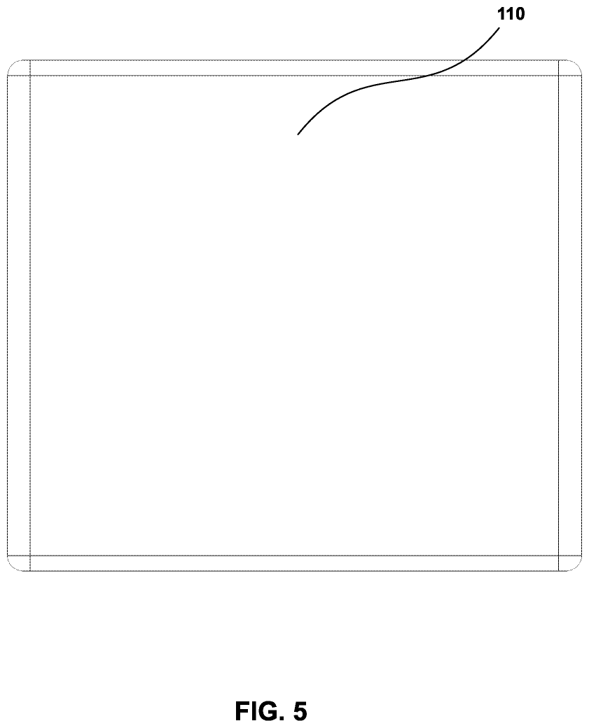

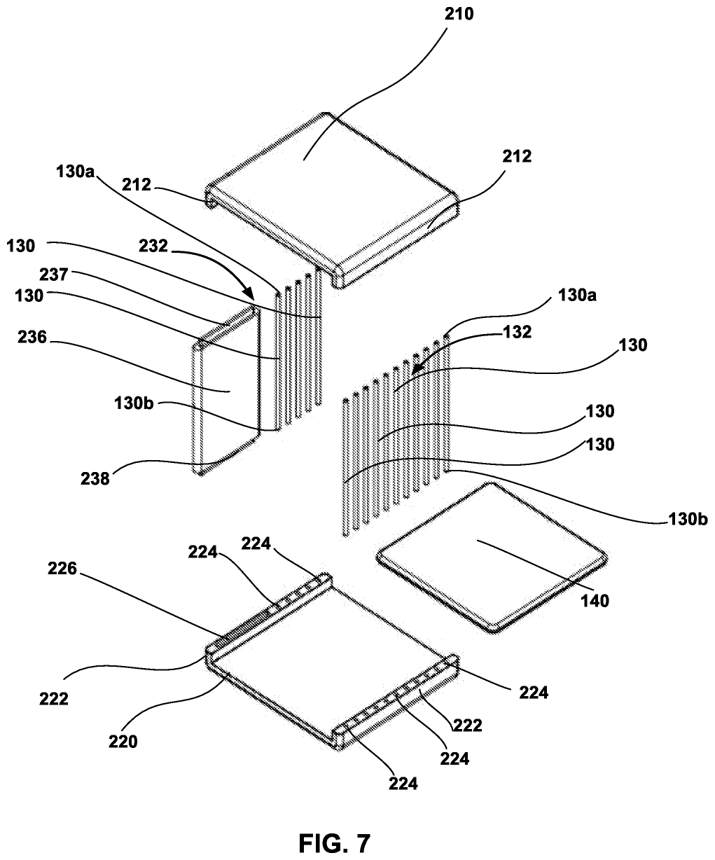

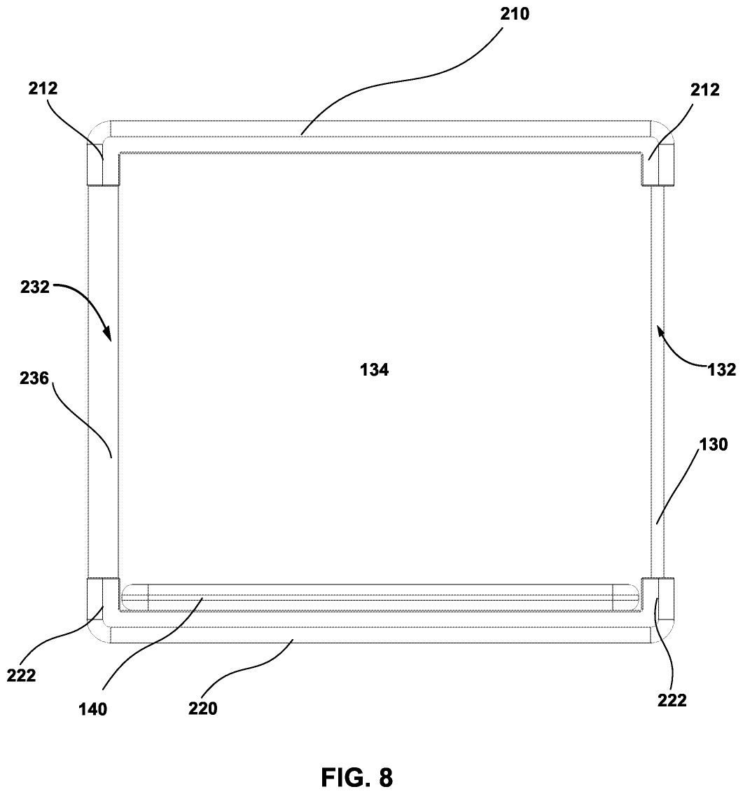

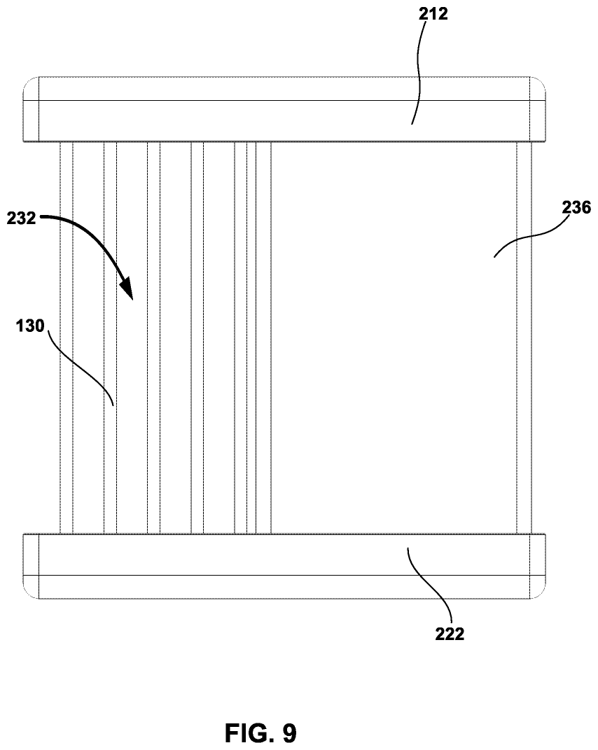

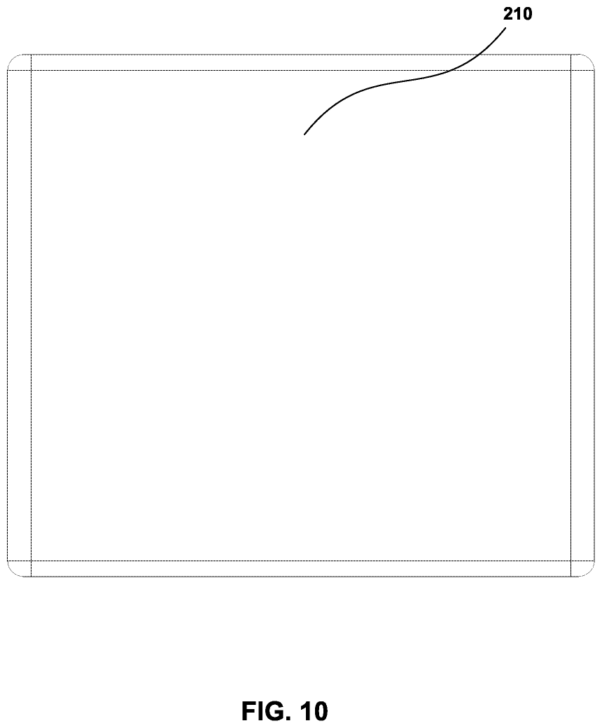

The various features and embodiments of pet bed, according to various embodiments of the present invention will now be described in conjunction with the accompanying figures, namely FIGS. 1-10.

FIGS. 1-5 illustrate an embodiment of the pet bed 100 for comfort of a pet animal. As shown in FIG. 1, the pet bed 100 comprises a top cover 110, a bottom cover 120 and a plurality of sidewalls 132 such that the top cover 110, the bottom cover 120 and the plurality of tubes sidewalls 132 are connected to define an enclosure for receiving atleast one pet animal. A plurality of tubes 130 are arranged relative to the top cover 110 and the bottom cover 120 such that the plurality of tubes 130 acts as sidewalls 132 of the pet bed 100 in assembled position as shown in FIG. 1. The Pet bed 100 has two open portions/doorways, herein referred to as door portions 134 such that the door portions 134 are adjacent to the sidewalls 132, top cover 110 and the bottom cover 120. Each door portion 134 enables atleast one pet to enter and/or exit the pet bed 100. As shown in FIG. 1, the top cover 110 comprises two extension portions 112 positioned on either sides of the top cover 110. Further, the bottom cover 120 comprises two extension portions 122 positioned on either sides of the bottom cover 120. Each extension portion 112 comprises a plurality of holes 114 (not shown in figures) for removably receiving a first end 130a of a plurality of tubes 130 such that each hole 114 (not shown in figures) is configured to removably receive a first end 130a of a tube 130. Each extension portion 122 comprises a plurality of holes 124 (not shown in figures) for removably receiving a second end 130b of a plurality of tubes 130 such that each hole 124 (not shown in figures) is configured to removably receive a second end 130b of a tube 130. Further, a cushion element 140 is removably positioned on the bottom cover 120 to provide a cushioning effect to the pet animal.

Method of assembling and disassembling the pet bed 100 now will be described in reference to FIGS. 1-5.

As shown in FIG. 1, the pet bed 100 is positioned in the assembled position. To disassemble the pet bed 100, the top cover 110 is detached from the plurality of tubes 130 by moving/pulling the top cover 110 apart from the plurality of tubes 130. By moving/pulling the top cover 110 apart from the plurality of tubes 130, the first end 130a of the plurality of tubes 130 are detached from the plurality of holes 114 (not shown in figures) of the top cover 110. Similarly, by moving/pulling the bottom cover 120 apart from the plurality of tubes 130, the second end 130b of the plurality of tubes 130 are detached from the plurality of holes 124 (not shown in figures) of the bottom cover 120. Afterwards, the cushion element 140 is removed from the bottom cover 120 by merely lifting the cushion element 140 from the bottom cover 120. Thus disassembly of the pet bed 100 is performed by the pulling/moving the top cover 110, bottom cover 120 and the plurality of tubes 130 apart from each other. Afterwards, the top cover 110, bottom cover 120 and the plurality of tubes 130 are stored in a secure package/location for later use. It should be obvious to the one skilled in the art that the method of disassembly described herein is exemplary and Further, disassembly of the pet bed 100 could be done with slight variations using above method. Further, few of the above steps of disassembly of the pet bed 100 could be omitted/modified to realize the objective of disassembly of the pet bed 100.

To bring the pet bed 100 in the assembled position as shown in FIG. 1, the above steps are performed in reverse order with little or no variation. Thus, the Pet bed 100 is easy and quick to assemble and disassemble as assembling and disassembling of the pet bed 100 is manually done by a pet owner/human operator by using minimal tool equipment (if required). Further, in the disassembled position, the Pet bed 100 occupies minimal space and thus, is easy to be transported due to less space requirements.

In an embodiment, the assembling and disassembling of the pet bed 100 is manually done by a pet owner/human operator without using any tools. In other words, the assembling and disassembling of the pet bed 100 is accomplished in tool-less manner which further reduces cost of operation of pet bed 100. Further, the tool-less pet bed 100 has advantages that it is more eco friendly as it eliminates need of any tool for assembly and disassembly of pet bed 100.

In an embodiment as shown in FIG. 1, the pet bed 100 has a quadrilateral shape. In another embodiment (not shown), the shape of the pet bed 100 could include but not limited to: polygon, circle, triangle and so on.

For the purposes of this invention, the terms “pet”, “pet animal” and “animal” shall be interchangeable and shall refer to any animal that is used with the present invention.

As shown in FIG. 1, the plurality of tubes 130 is cylindrical in nature and the cross section of the plurality of tubes 130 is uniform (i.e. circular) along entirety of the length of the plurality of tubes 130. Further, the plurality of holes 114 (not shown in figures) and plurality of holes 124 (not shown in figures) are cylindrical in nature to removably receive plurality of tubes 130. However, it should be obvious to the one skilled in the art that the plurality of tubes 130, plurality of holes 114 (not shown in figures) and plurality of holes 124 (not shown in figures) could have any other shape including but not limited to: rectangle, square, triangle, octagon and so on. Further, it should be obvious to the one skilled in the art that the cross section of the plurality of tubes 130 could be non-uniform along entirety of the length of the plurality of tubes 130.

In another embodiment (not shown in figures), the plurality of tubes 130, plurality of holes 114 (not shown in figures) and/or plurality of holes 124 (not shown in figures) includes a friction lining material to facilitate a stronger connection between the plurality of tubes 130 and the plurality of holes 114 (not shown in figures)/plurality of holes 124. The friction lining material could include but not limited to: paper, elastomerics, graphitics, phenol resins and sintered metals and so on.

In an embodiment, the material of the pet bed 100 could include but not limited to: wood, plastics, metal, rubber, polymers, composites and so on.

In another embodiment, the pet bed 100 is integrally formed (connected) such that the top cover 110, the bottom cover 120 and the plurality of tubes 130 are permanently attached to define a rigid enclosure for receiving atleast one pet animal. The permanent attachment methods/techniques could include but not limited to: welding, molding, 3D printing, woodworking and so on.

In an embodiment as shown in FIGS. 1-5, the top cover 110 comprises two extension portions 112 positioned on either sides of the top cover 110. The bottom cover 120 comprises two extension portions 122 positioned on either sides of the bottom cover 120. According to an embodiment, the two extension portions 112 are integrally formed (connected) with the top cover 110 and the two extension portions 122 are integrally formed (connected) with the bottom cover 120. According to another embodiment, the two extension portions 112 are removably connected to the top cover 110 and the two extension portions 122 are removably connected to the bottom cover 120.

For the purposes of this invention, the terms “plurality of tubes” could include any number of tubes greater than one such as but not limited to: tow, three, four, five, sex, seven, eight and so on. Further, the tubes could be solid or hollow depending on the required strength and endurance of the pet bed 100.

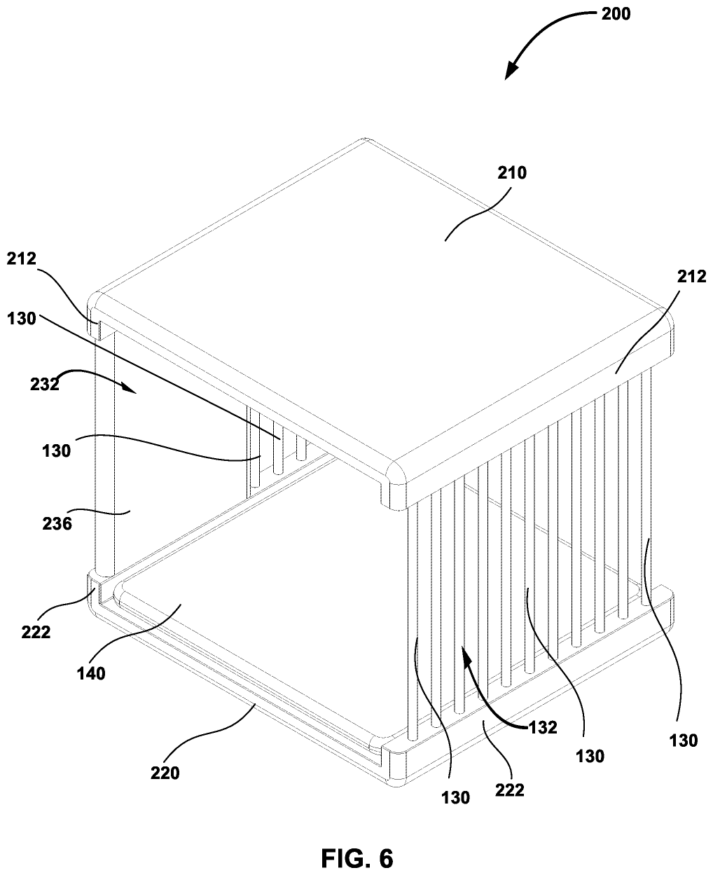

FIGS. 6-10 illustrate another embodiment of the pet bed 200 for comfort of a pet animal. The pet bed 200 is pretty similar to the pet bed 100 shown in FIGS. 1-5 except for the geometrical modifications associated with addition of scratcher. The pet bed 200 comprises a top cover 210 and a bottom cover 220. As shown in FIGS. 6-10, a first sidewall 232 is formed of a plurality of tubes 130 and atleast one scratcher 236 and the second sidewall 132 is formed from a plurality of tubes 130 identical to the sidewall 132 in FIGS. 1-5. The scratcher 236 is an elongated pad designed for enabling scratching of pet such that the pet can express their urge of scratching on the scratcher 236 while using the pet bed 200. As seen in FIGS. 6-10, the scratcher 236 comprises two elongate protrusions; labeled as a first elongate protrusion 237 and a second elongate protrusion 238 positioned at a first end and an opposite second end of the scratcher 236 respectively. Further, the top cover 210 comprises two extension portions 212 positioned on either sides of the top cover 210. Each extension portion 212 comprises a plurality of holes 214 (not shown in figures) for removably receiving a first end 130a of a plurality of tubes 130 such that each hole 214 (not shown in figures) is configured to removably receive a first end 130a of a tube 130. Further, atleast one extension portion 212 comprises an elongate slot 216 (not shown in figures) to removably receive a first elongate protrusion 237 of the scratcher 236. Further, the bottom cover 220 comprises two extension portions 222 positioned on either sides of the bottom cover 220. Each extension portion 222 comprises a plurality of holes 224 for removably receiving a second end 130b of a plurality of tubes 130 such that each hole 124 (not shown in figures) is configured to removably receive a second end 130b of a tube 130. Further, atleast one extension portion 222 comprises an elongate slot 226 to removably receive a second elongate protrusion 238 of the scratcher 236. Further, a cushion element 140 is removably positioned on the bottom cover 220 to provide a cushioning effect to the pet animal.

As shown in FIGS. 6-10, the plurality of tubes 130, the top cover 210, the bottom cover 220 and the scratcher 236 are arranged relative to one another such that the top cover 210, the bottom cover 220, the first sidewall 232 and the second sidewall 132 are connected to define an enclosure for receiving atleast one pet animal. The Pet bed 200 has two open portions/doorways, herein referred to as door portions 134 identical to the door portion 134 of FIGS. 1-5 such that the door portions 134 are adjacent to the first sidewall 232, second sidewall 132, top cover 210 and the bottom cover 220. Each door portion 134 enables atleast one pet to enter and exit the pet bed 200.

Method of assembling and disassembling the pet bed 200 now will be described in reference to FIGS. 6-10.

As shown in FIG. 6, the pet bed 200 is positioned in the assembled position. To disassemble the pet bed 200, the top cover 210 is detached from the plurality of tubes 130 and the scratcher 236 by moving/pulling the top cover 210 apart from the plurality of tubes 130 and the scratcher 236. By moving/pulling the top cover 110 apart from the plurality of tubes 130 and the scratcher 236, the first end 130a of the plurality of tubes 130 are detached from the plurality of holes 214 (not shown in figures) of the top cover 210 and the first elongate protrusion 237 of the scratcher 236 is detached from the elongate slot 216 (not shown in figures) of the top cover 210 respectively. Similarly, by moving/pulling the bottom cover 220 apart from the plurality of tubes 130, the second end 130b of the plurality of tubes 130 are detached from the plurality of holes 224 of the bottom cover 220 and the second elongate protrusion 238 of the scratcher 236 is detached from the elongate slot 226 of the bottom cover 220. Afterwards, the cushion element 140 is removed from the bottom cover 220 by merely lifting the cushion element 140 from the bottom cover 220. Thus, disassembly of the pet bed 200 is performed by the pulling/moving the top cover 210, bottom cover 220, scratcher 236 and the plurality of tubes 130 apart from each other. Afterwards, the top cover 210, bottom cover 220, scratcher 236 and the plurality of tubes 130 are stored in a secure package/location for later use. It should be obvious to the one skilled in the art that the method of disassembly described herein is exemplary and Further, disassembly of the pet bed 200 could be done with slight variations using above method. Further, few of the above steps of disassembly of the pet bed 200 could be omitted/modified to realize the objective of disassembly of the pet bed 200.

To bring the pet bed 200 in the assembled position as shown in FIG. 1, the above steps are performed in reverse order with little or no variation. Thus, the Pet bed 200 is easy and quick to assemble and disassemble as assembling and disassembling of the pet bed 200 is manually done by a pet owner or a human operator by using minimal tool equipment (if required). Further, in the disassembled position, the Pet bed 200 occupies minimal space and thus, is easy to be transported due to less space requirements.

In an embodiment as shown in FIG. 6, the pet bed 200 has a quadrilateral shape. In another embodiment (not shown), the shape of the pet bed 200 could include but not limited to: polygon, circle, triangle and so on.

For the purposes of this invention, the terms “pet”, “pet animal” and “animal” shall be interchangeable and shall refer to any animal that is used with the present invention.

As shown in FIG. 6, the plurality of tubes 130 is cylindrical in nature and the cross section of the plurality of tubes 130 is uniform (i.e. circular) along entirety of the length of the plurality of tubes 130. Further, the plurality of holes 114 (not shown in figures) and plurality of holes 124 (not shown in figures) are cylindrical in nature to removably receive plurality of tubes 130. However, it should be obvious to the one skilled in the art that the plurality of tubes 130, plurality of holes 114 (not shown in figures) and plurality of holes 124 (not shown in figures) could have any other shape including but not limited to: rectangle, square, triangle, octagon and so on. Further, it should be obvious to the one skilled in the art that the cross section of the plurality of tubes 130 could be non-uniform along entirety of the length of the plurality of tubes 130.

In another embodiment (not shown in figures), the plurality of tubes 130, plurality of holes 214 (not shown in figures) and/or plurality of holes 224 includes a friction lining material to facilitate a stronger connection between the plurality of tubes 130 and the plurality of holes 214 (not shown in figures)/plurality of holes 224. The friction lining material could include but not limited to: paper, elastomerics, graphitics, phenol resins and sintered metals and so on.

In an embodiment, the material of the pet bed 200 could include but not limited to: wood, plastics, metal, rubber, polymers, composites and so on.

In another embodiment, the pet bed 200 is integrally formed (connected) such that the top cover 210, the bottom cover 220 and the plurality of tubes 130 are permanently attached to define a rigid enclosure for receiving atleast one pet animal. The permanent attachment methods/techniques could include but not limited to: welding, molding, 3D printing, woodworking and so on.

In an embodiment as shown in FIGS. 1-5, the top cover 210 comprises two extension portions 212 positioned on either sides of the top cover 210. The bottom cover 220 comprises two extension portions 222 positioned on either sides of the bottom cover 220. According to an embodiment, the two extension portions 212 are integrally formed (connected) with the top cover 210 and the two extension portions 222 are integrally formed (connected) with the bottom cover 220. According to another embodiment, the two extension portions 212 are removably connected to the top cover 210 and the two extension portions 222 are removably connected to the bottom cover 220.

For the purposes of this invention, the terms “plurality of tubes” could include any number of tubes greater than one such as but not limited to: tow, three, four, five, sex, seven, eight and so on. Further, the tubes could be solid or hollow depending on the required strength and endurance of the pet bed 200.

In another embodiment (not shown in figures), the pet bed is configured such that both sidewalls are formed of a plurality of tubes 130 and atleast one scratcher 236. In other words, the pet bed comprises a first sidewall 232 formed of atleast one scratcher 236 and a plurality of tubes 130 and further, the pet bed comprises a second sidewall 232 opposite to the first sidewall 232 wherein the second sidewall 232 is also formed of atleast one scratcher 236 and a plurality of tubes 130.

In an embodiment, the scratcher 236 is an elongated pad designed for enabling scratching of pet such that the pet can express their urge of scratching on the scratcher 236 while using the pet bed 200. The scratcher 236 is formed of a rough material that allows pets to scratch the scratcher 236 and the material can include but not limited to: fabric, wood, sisal, wool and so on. In other embodiment, the scratcher 236 could include a replaceable covering (not shown) that can be applied/rolled/secured on the outer surface of the scratcher 236. The replaceable covering (not shown) could be used by pet and once the replaceable covering (not shown) is unsuitable for use due to factors such as but not limited to: wear and tear, environmental degradation, pet owner choice and so on, then the old unsuitable replaceable covering could be replaced by a new replaceable covering for further use by pet.

In an embodiment shown in FIGS. 6-10, first sidewall 232 is formed of a plurality of tubes 130 and atleast one scratcher 236 such that the scratcher 236 forms up (occupies) substantially fifty percent of total dimensions of the first sidewall 232 and the plurality of tubes 130 collectively forms up (occupies) substantially remaining fifty percent of overall dimensions of the first sidewall 232. However, it should be obvious to the one skilled in the art that the scratcher 236 could have any dimensions such that the scratcher 236 forms up (occupies) a percentage ranging from 5 percent to 95 percent of overall dimensions of the first sidewall 232.

In another embodiment (not shown in figures), the scratcher 236 forms up hundred percent of total dimensions of the first sidewall 232 such that the first sidewall 232 is formed from only scratcher 236 and the first sidewall 232 does not comprise any tubes 130.

In another embodiment (not shown in figures), a first sidewall 232 is formed of atleast two scratchers 236 and a plurality of tubes 130.

In another embodiment (not shown in figures), the door portions 134 of the pet bed (100, 200) could have entry doors (not shown) for entry and/or exit of the pet animal from the pet bed (100, 200).

In another embodiment (not shown in figures), the pet bed (100, 200) comprises wheels (not shown in figures) and a carrying handle (not shown in figures) for facilitating transport of pet animals in assembled position.

The pet bed (100, 200) of the present invention is not limited to any particular shape and size. For example, small pet beds may be suitable for use with, for example, small animals such as cats, kittens, puppies, small dogs and other small animals (e.g., skunks, hamsters, guinea pigs, etc.). Medium pet beds are useful, for example, with medium sized dogs. Large pet beds may be used with, for example, large dogs, small pigs (e.g. pot bellied pigs), etc. The actual size of the pet bed (100, 200) of the present invention is not considered a limiting embodiment of the present invention.

It should be understood that pet beds (100, 200) may be constructed using any conventional manufacturing processes such as but not limited to molding, wood working, machining, casting, 3D printing and so on. Further, it should also be understood that the pet beds (100, 200) are pretty similar and various embodiments of the present invention could also be considered interchangeably for both pet beds (100, 200).

It should be understood that term “pet bed” broadly includes any structure that could be used by a pet animal for various purposes. The purposes of the “pet bed” could include but not limited to: comfort purposes, pet sleep, pet shelter and pet transport and so on.

It should be understood according to the preceding description of the present invention that the same is susceptible to changes, modifications and adaptations, and that the said changes, modifications and adaptations fall within scope of the appended claims.

What is claimed is:

1. A pet bed (100) that can be easily brought from an assembled position to a disassembled position and vice versa; the pet bed (100) comprising:—
a top cover (110) comprising two extension portions (112) positioned on either sides of the top cover (110); wherein each extension portion (112) comprises a plurality of holes (114);
a bottom cover (120) comprising two extension portions (122) positioned on either sides of the bottom cover (120); wherein each extension portion (122) comprises a plurality of holes (124);
a plurality of sidewalls (132) wherein each sidewall (132) is formed from a plurality of tubes (130): each tube (130) comprising a first end (130a) and an opposite second end (130b);
Wherein in the assembled position, the first end (130a) of the plurality of tubes (130) is removably received in the plurality of holes (114) of the extension portion (112); and the second end (130b) of the plurality of tubes (130) is removably received in the plurality of holes (124) of the extension portion (122); such that the top cover (110), the bottom cover (120) and the plurality of sidewalls (132) are connected to define an enclosure for receiving at least one pet animal; and
Wherein in the disassembled position, the first end (130a) of the plurality of tubes (130) is detached from the plurality of holes (114) of the extension portion (112); and the second end (130b) of the plurality of tubes (130) is detached from the plurality of holes (124) of the extension portion (122).

2. The pet bed (100) according to claim 1, wherein the pet bed (100) comprises a cushion element (140) removably positioned on the bottom cover (120) to provide a cushioning effect to the pet animal.

3. The pet bed (100) according to claim 1, wherein the pet bed comprises two door portions (134) for entry and/or exit of the pet animal from the pet bed (100).

4. The pet bed (100) according to claim 1, wherein the plurality of tubes (130), plurality of holes (114) and/or plurality of holes (124) includes a friction lining material to facilitate a stronger connection between the plurality of tubes (130) and the plurality of holes (114) and/or plurality of holes (124);

5. The pet bed (200) that can be easily brought from an assembled position to a disassembled position and vice versa; the pet bed (200) comprising:—
a top cover (210) comprising two extension portions (212) positioned on either sides of the top cover (210); wherein each extension portion (212) comprises a plurality of holes (214) and an elongate slot (216);
a bottom cover (220) comprising two extension portions (222) positioned on either sides of the bottom cover (220); wherein each extension portion (222) comprises a plurality of holes (224) and an elongate slot (226);
at least one first sidewall (232) and at least one second sidewall (132,232); Wherein the at least one first sidewall (232) is formed from a plurality of tubes (130) and atleast one scratcher (236): wherein each tube (130) comprising a first end (130a) and an opposite second end (130b); wherein each scratcher (236) comprises a first elongate protrusion (237) and an opposite second elongate protrusion (238); and
wherein in the assembled position, the first end (130a) of the plurality of tubes (130) is removably received in the plurality of holes (214) of the extension portion (212); the second end (130b) of the plurality of tubes (130) is removably received in the plurality of holes (224) of the extension portion (222); the first elongate protrusion (237) of the scratcher (236) is removably received in the elongate slot (216) of the top cover (210) and the second elongate protrusion (238) of the scratcher (236) is removably received in the elongate slot (226) of the bottom cover (220) such that the top cover (210), the bottom cover (220), the first sidewall(s) (232) and the second sidewall(s) (132,232) are connected to define an enclosure for receiving atleast one pet animal; and
wherein in the disassembled position, the first end (130a) of the plurality of tubes (130) is detached from the plurality of holes (214) of the extension portion (212); the second end (130b) of the plurality of tubes (130) is detached from the plurality of holes (224) of the extension portion (222); the first elongate protrusion (237) of the scratcher (236) is detached from the elongate slot (216) of the top cover (210) and the second elongate protrusion (238) of the scratcher (236) is detached from the elongate slot (226) of the bottom cover (220).

6. The pet bed (200) according to claim 5, wherein the pet bed (200) comprises a cushion element (140) removably positioned on the bottom cover (220) to provide a cushioning effect to the pet animal.

7. The pet bed (200) according to claim 5, wherein the pet bed comprises two door portions (134) for entry and/or exit of the pet animal from the pet bed (200).

8. The pet bed (200) according to claim 5, wherein the plurality of tubes (130), plurality of holes (214) and/or plurality of holes (224) includes a friction lining material to facilitate a stronger connection between the plurality of tubes (130) and the plurality of holes (214) and/or plurality of holes (224);

9. The pet bed (200) according to claim 5, wherein the second sidewall (132,232) is formed from at least one scratcher (236) and a plurality of tubes (130);

10. The pet bed (200) according to claim 5, wherein the second sidewall (132,232) is formed from a plurality of tubes (130);

11. The pet bed (200) according to claim 5, wherein the scratcher (236) comprises a replaceable covering that can be secured on the outer surface of the scratcher (236).

12. The pet bed (200) according to claim 5, wherein the scratcher (236) forms up a percentage ranging from 5 percent to 95 percent of overall dimensions of the first sidewall (232).
